(19) United States
(12) Patent Application Publication
(10) Pub. No.: US 2009/0237190 A1
(43) Pub. Date: Sep. 24, 2009

(54) TRIPPING MODULE FOR A SWITCH DEVICE

(75) Inventor: ALFRED NYZNER, Wien (AT)

Correspondence Address: HENRY M FEIEREISEN, LLC;HENRY M FEIEREISEN, 708 THIRD AVENUE, SUITE 1501, NEW YORK, NY, 10017, US

(73) Assignee: Moeller Gebaudeautomation GmbH, Schrems (AT)

(21) Appl. No.: 12/408,296

(22) Filed: Mar. 20, 2009

Related U.S. Application Data
(60) Provisional application No. 61/038,243, filed on Mar. 20, 2008.

(30) Foreign Application Priority Data
Mar. 20, 2008 (AT) A 445/2008

(51) Int. Cl. H01H 9/00

(52) U.S. Cl. 335/174

(57) ABSTRACT

A tripping module for a switching device includes at least a magnetic system having at least an armature, a coil, and a yoke. The coil is arranged about the armature, and the yoke is arranged about the coil. The armature is provided for tripping at least indirectly a disconnecting apparatus of the switching device. In order to increase security in electric installation arrangements, the yoke includes at least a bent sheet-metal part.

### CROSS-REFERENCES TO RELATED APPLICATIONS

This application claims the benefit of prior filed U.S. Provisional Application No. 61/038,243, filed Mar. 20, 2008, pursuant to 35 U.S.C. 119(e).

This application claims also the priority of Austrian Patent Application, Serial No. A 445/2008, filed Mar. 20, 2008, pursuant to 35 U.S.C. 119(a)-(d).

The contents of U.S. Provisional Application No. 61/038,243, and Austrian Patent Application, Serial No. A 445/2008 are incorporated herein by reference in its entirety as if fully set forth herein.

### BACKGROUND OF THE INVENTION

The present invention relates, in general, to a tripping module for a switch device.

The following discussion of related art is provided to assist the reader in understanding the advantages of the invention, and is not to be construed as an admission that this related art is prior art to this invention.

Tripping modules can be coupled with circuit breakers to realize additional functions such as a remote-controlled cut-off or further tripping functions, and typically have a magnetic system to actuate a mechanical trip element of the circuit breaker. These tripping modules are complex and are difficult to produce. Especially the complex configuration of the magnetic system renders the production of the tripping module very costly. As a result of the high costs, consumers avoid installation of such tripping modules and thus are unable to get the benefit of the useful added functions and security features.

It would therefore be desirable and advantageous to provide an improved tripping module to obviate prior art shortcomings and to increase security in electric installation arrangements in a simple and cost-efficient manner.

### SUMMARY OF THE INVENTION

According to one aspect of the present invention, a tripping module for a switching device includes at least a magnetic system including at least an armature constructed for tripping at least indirectly a disconnecting apparatus of a switching device, a coil arranged about the armature, and a yoke arranged about the coil and including at least a bent sheet-metal part.

A tripping module in accordance with the present invention can be produced in a simple way at low cost. As a result of the simple production of the yoke which requires only very low technical skills, such a module can also be produced with ease in developing countries. As a result of the low production costs, such a module can be marketed at low cost, thus promoting the readiness to implement further security features. Security and reliability in electric installation arrangements can thus be increased.

According to another advantageous feature of the present invention, the bent sheet-metal part may be a bent punched part.

According to another advantageous feature of the present invention, the yoke may be made of a predetermined number of bent sheet-metal parts.

According to another advantageous feature of the present invention, the yoke may include a substantially U-shaped yoke base body and a substantially planar yoke cover for connection to the base body. The yoke base body and the yoke cover may hereby be connected by a plug-in connection to close the yoke. Advantageously, the yoke base body may have a first region disposed in opposite relationship to the yoke cover and including a breakthrough for passage of the armature.

According to another advantageous feature of the present invention, the coil may include a coil body and a coil winding arranged on the coil body.

According to another advantageous feature of the present invention, at least one first spacer plate may be arranged between the yoke cover and the coil winding. The first spacer plate may be held in or on the coil body.

According to another advantageous feature of the present invention, the yoke base body, the yoke cover, the armature, and/or the first spacer plate may contain ferromagnetic material.

According to another advantageous feature of the present invention, the tripping module may be constructed in the form of a shunt release, with at least one permanent magnet being arranged between the first spacer plate and the coil winding.

According to another advantageous feature of the present invention, the tripping module may be constructed in the form of an undervoltage release, with a second spacer plate which contains ferromagnetic material being arranged between the yoke cover and the first spacer plate.

According to another advantageous feature of the present invention, the tripping module may be constructed as part of the switching device, such as a circuit breaker.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows an axonometric view of one embodiment of a tripping module in accordance with the invention;

FIG. 2 shows an axonometric exploded view of the tripping module of FIG. 1;

FIG. 3 shows a side elevation of the tripping module of FIG. 2, without housing cover;

FIG. 4 shows an exploded view of a magnetic system of a tripping module in accordance with the invention arranged as a shunt release;

FIG. 5 shows an exploded view of a magnetic system of a tripping module in accordance with the invention arranged as an undervoltage release;

FIG. 6 shows a sectional view of the magnetic system of FIG. 4 in on-position;

FIG. 7 shows a sectional view of the magnetic system of FIG. 5 in off-position;

FIG. 8 shows an axonometric exploded view of a circuit breaker.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

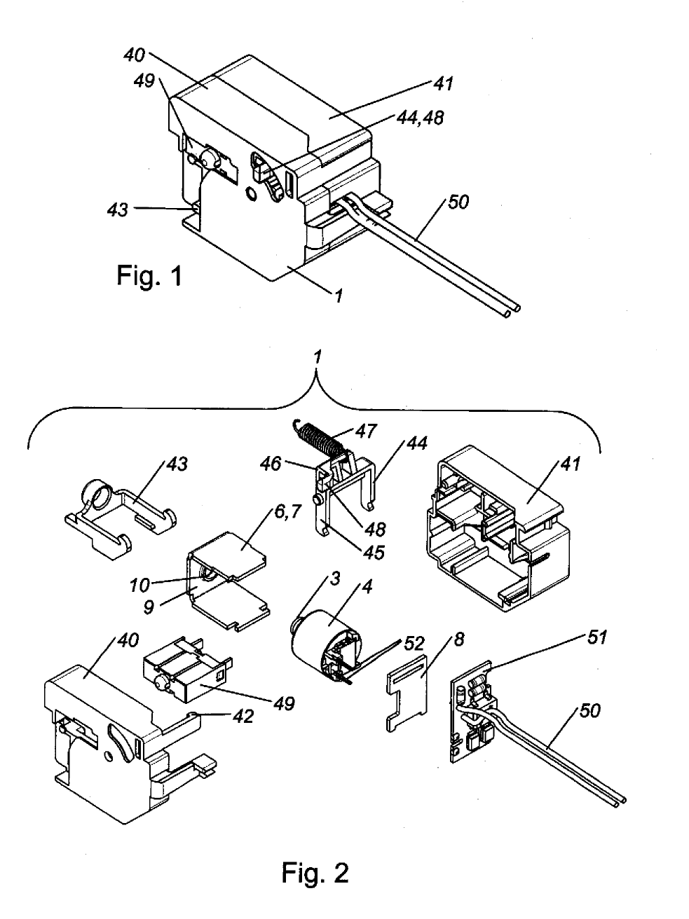

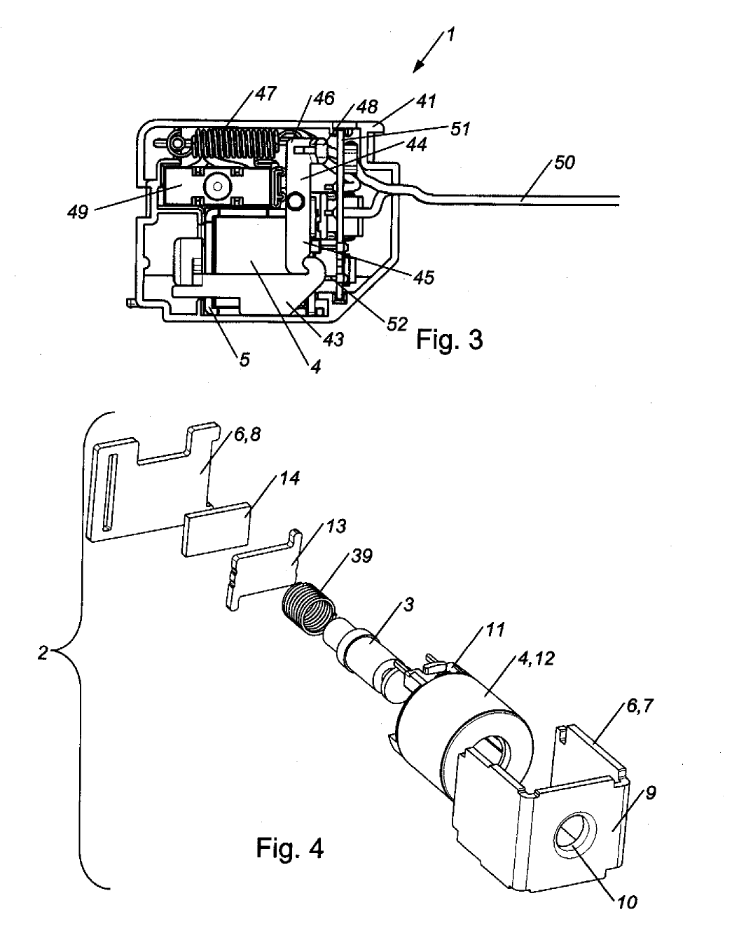

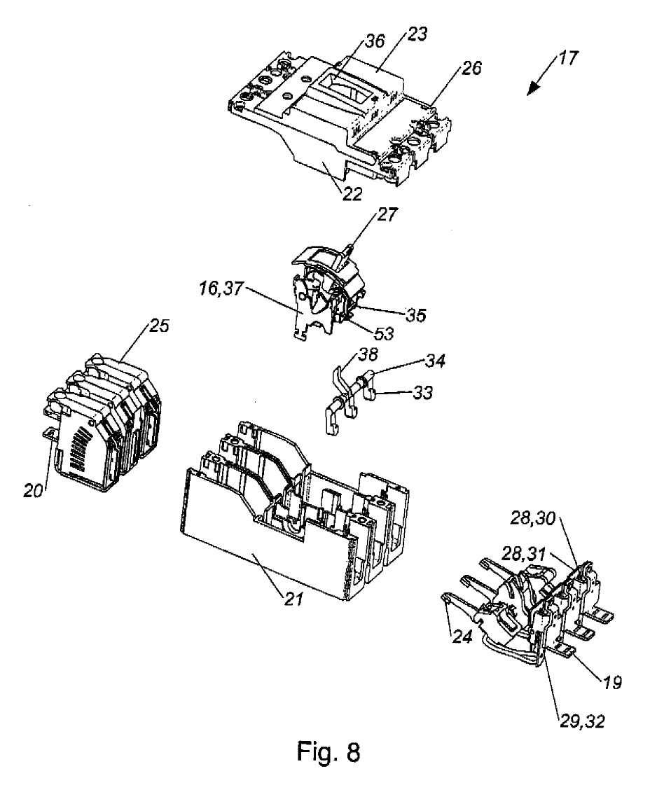

FIGS. 1 to 3 show a tripping module 1 for a switching device. The tripping module 1 includes at least one magnetic system 2 having at least one armature 3, a coil 4 and a yoke 5. The coil 4 is arranged about the armature 31 and the yoke 5 is arranged about the coil 4 and includes at least one bent plate part 6, especially a punched bent part. The armature 3 is hereby provided for the at least indirect tripping of a disconnecting apparatus 16 of a switching device. The tripping module 1 is applicable as a circuit breaker 17, shown in FIG. 8, which is easy to produce and cost-efficient. As a result of the simple production of yoke 5 which requires only very low technical skills, the tripping module 1 can also simply be produced in developing countries. As a result of the low production costs, the tripping module 1 can be marketed at low cost, thus supporting the willingness to implement further security features. The security of electrical installation arrangements can thus be increased.

The tripping module 1 in accordance with the invention is provided or arranged to actuate or trip the disconnection apparatus 16 of a switching device, especially a circuit breaker 17. It is preferably provided in this respect that the tripping module 1 is in mechanical contact at least in sections with the circuit breaker 17 during operation or is at least partly integrated in the circuit breaker 17. The terms “switching device” and “circuit breaker” are used synonymously in the following description with reference to the preferred embodiment of a switching device as a circuit breaker 17. The description with the reference to a circuit breaker 17 preferably does not exclude any other switching devices.

FIG. 8 shows an axonometric exploded view of a number of modules of a preferred embodiment of a circuit breaker 17. An embodiment of a circuit breaker 17 is shown with three breaks or paths of the current, with any predeterminable number of breaks or switchable paths of current being provided. Preferably, circuit breakers 17 are provided one, two, three or four current paths. According to the number of the current paths, the same number of input terminals 19 or output terminals 20 is provided. FIG. 8 merely shows the parts of the input terminals 19 and output terminals 20 which are fixed to the housing. In addition to the illustrated parts, the respective input terminals 19 and output terminals 20 usually each comprise at least one terminal screw and preferably at least one terminal cage which is movable by means of the terminal screw. The at least one switching contact 24 lies in a closed position on the at least one second switching contact which in the illustrated embodiment is arranged invisibly within the module of the arc-extinguishing chamber 25.

Preferred embodiments of a circuit breaker 17 involve a short-circuit tripping apparatus 28 and/or an overcurrent tripping apparatus 29. The short-circuit tripping apparatus 28 is preferably formed by a metal bracket 30 and a clapper-type armature 31 which are preferably associated with the input terminal 19 and/or the output terminal 20. When a short circuit occurs, the clapper-type armature 31 is attracted by the metal bracket 30, and causes the further tripping of the disconnection apparatus 16 and consequently the separating of the switching contacts 24.

The overcurrent tripping apparatus 29 includes a bimetallic element 32 which is preferably associated with the input terminal 19 and/or the output terminal 20. Current flows directly through the bimetallic element 32, according to the illustrated embodiment of a circuit breaker 17. In the case of a predeterminable degree of bending of the bimetallic element 32, which is proportional to a predeterminable heating of the line network, it moves a tripping projection 33 of a deflecting lever 34 which causes the further tripping of the disconnection apparatus 16 and consequently the separation of the switching contacts.

The circuit breaker 17 includes an insulant housing which has a bottom housing shell 21 and an upper housing shell 22. The upper housing shell 22 has a housing cover 23 which is held on the upper housing shell 22 in a pivoting manner, preferably by means of hinges 26, and includes an opening 36 for the actuating lever 27. The upper housing shell 22 has at least one receptacle for a tripping module 1 in accordance with the invention, which receptacle is covered by the closed housing cover 23 in the illustration according to FIG. 8. The tripping module 1 is provided for the at least indirect tripping of a disconnecting apparatus 16 of a circuit breaker 17. Further openings are provided in the area of the receptacle for the tripping module 1, through which the tripping module 1 can enter into a mechanical interaction with the disconnecting apparatus 16, or through which the tripping module 1 can act mechanically upon the disconnecting apparatus 16.

In the illustrated embodiment of a circuit breaker 17, the disconnecting apparatus is arranged as a breaker mechanism 37, as shown in FIG. 8. The breaker mechanism 37 is an energy-storing link between an actuating lever 27 and the switching contacts 24. The breaker mechanism 37 is tensioned in a first step in a first direction of movement by means of movement of the actuating lever 27, with a spring-force storage means being tensioned which during the tripping of the breaker mechanism 37 ensures a rapid and secure disconnection of the switching contacts 24. The tensioning process is ended by locking, arresting or latching of a latch 35 on a part of the breaker mechanism 37 which is fixed to the housing. In a second step, the switching contacts 24 are closed by means of movement of the actuating lever 27 in a second direction. The latched connection of latch 35 with the part of breaker mechanism 37 fixed to the housing is arranged in such a way that a predeterminable movement of latch 35 in a predeterminable direction unlatches the breaker mechanism 37, through which the spring-force storage means is released and the switching contacts 24 are disconnected. Examples of a breaker mechanism 37 are described in German patent documents DE 42 27 213 A1 and DE 44 42 417, to which reference is made herewith. When the deflecting lever 34 is moved by a movement of the overcurrent tripping apparatus 29 and/or the short-circuit tripping apparatus 28, especially by a movement of the clapper-type armature 31 and/or the bimetallic element 32, the actuating projection 38 of the deflecting lever 34 comes into engagement with the latch 35, following a predeterminable movement of the deflecting lever 34, and moves the latch 35 so far that the latched connection with the part of the breaker mechanism 37 fixed to the housing is released, through which the breaker mechanism 37 is unlatched, the spring-force storage means is released and the switching contacts 24 are disconnected. The tripping module 1 can also act upon the latch 35 of the breaker mechanism 37 through the openings in the upper housing shell 22. For this purpose, the latch 35 may include a special latch projection 53 which protrudes into the receptacle in the region of the upper housing shell 22.

The tripping module 1 includes at least one magnetic system 2 which has at least one movable armature 3, at least one coil 4 fixed to the housing and at least one yoke 5 fixed to the housing. The movable armature 3 is arranged as a plunger-type armature which is guided in the interior of the coil 4 and is provided for the at least indirect tripping of the disconnecting apparatus 16 of a circuit breaker 17. It is preferably provided in this respect that the coil 4 has a coil body 11 and a coil winding 12 arranged on the same, through which the production of the coil 4 and the tripping module 1 are supported advantageously. Yoke 5 is arranged about the coil 4 and is used for guiding a magnetic field generated or caused by the coil 4 or a permanent magnet 14. It is preferably provided in this connection that at least the yoke 5 and the armature 3 are made of a ferromagnetic material or comprise at least such a one. It is preferably provided that the yoke 5 is made of a ferromagnetic iron or nickel base alloy, e.g. of electrical sheet.

In accordance with the invention, the yoke 5 includes at least one bent sheet-metal part 6. The bent sheet-metal part 6 can be formed through any production method such as punching, cutting or machining process such as filing or sawing. Advantageously, the at least one bent sheet metal part 6 is arranged as a bent punched part, thus ensuring an especially rational and cost-effective production. Yoke 5 can be arranged completely as an integral bent sheet-metal part 6. The yoke 5 is advantageously made of a predeterminable number of bent sheet-metal parts 6, by means of which the production costs can be reduced even further. It is provided in this context, as is shown in the FIGS. 1, 4, 5, 6 and 7, that the yoke 5 has a substantially U-shaped yoke base body 7 and a substantially planar yoke cover 8. This ensures very simply production in combination with favorable magnetic properties. The yoke base body 7 and the yoke cover 8 are connected by means of at least one plug-in connection and form a closed yoke 5. Very simple production can be realized by a plug-in connection because it is possible to omit connection means or connection techniques such as welding or soldering. The plug-in connection is preferably arranged by ensuring field transition that offers the lowest possible loss between the individual parts of yoke 5 and preferably comprises especially small air gaps or magnetic resistances.

The tripping module 1 is further provided with at least a first spacer plate 13 arranged between the yoke cover 8 and the coil winding 12. The spacer plate 13 is preferably made of a ferromagnetic material, through which the magnetic circuit formed by the yoke 5 and the armature 3 can be further optimized. The assembly of the magnetic system 2 and the entire tripping module 1 can be further improved by holding the at least first spacer plate 13 in or on the coil body 11.

To adjust the response voltage or to set defined field relationships within the terms of quality-securing measures, a so-called air-gap plate made of non-magnetic material is inserted between the yoke cover 8 and the at least one spacer plate 13 or an optionally provided permanent magnet 14. The properties of the magnetic system 2 are thus reproducible.

As already described above, the armature 3 is held and/or guided in the interior of coil 4, and it is provided to act in a mechanical manner on a tripping element or latch 35 of the disconnecting apparatus 16 of a switching device. The armature 3 is therefore provided to be moved forward from the magnetic system 2, at least in sections and at least for interaction with the switching device. For this purpose, the yoke base body 7 has at least one breakthrough 10 in a first region 9 arranged opposite of the yoke cover 8, through which the armature 3 is guided.

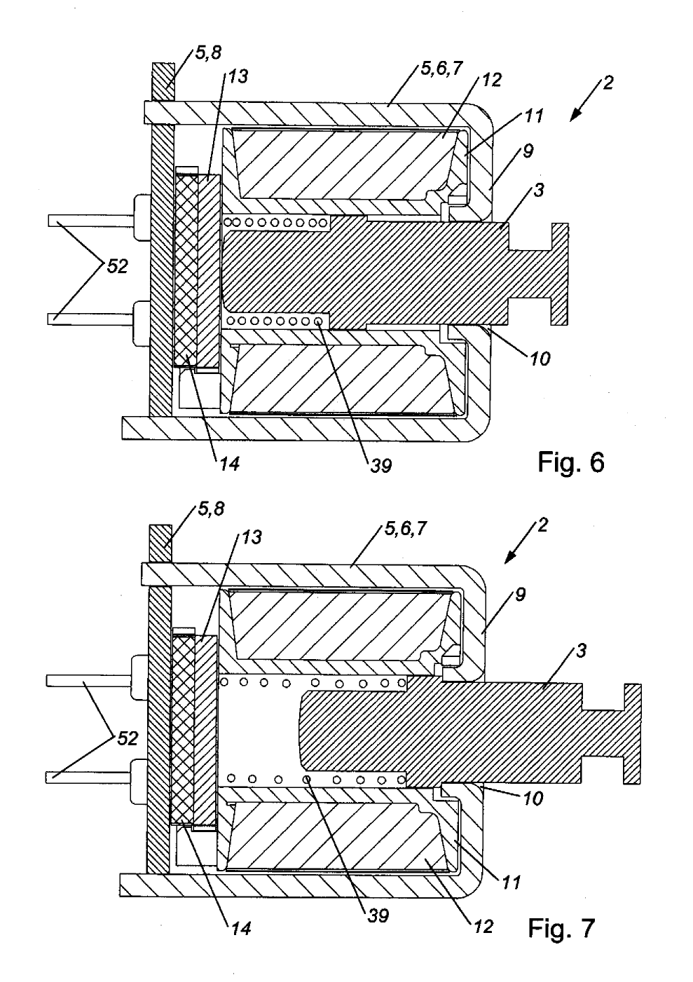

To provide a defined end position of the armature 3 with respect to coil 4, the armature 3 is pushed away or pulled away from the first spacer plate 13 by at least one armature spring 39. Suitably, at least one armature spring 39 is arranged within the coil 4 and configured as a pressure spring to press the armature 3 out of the coil 4, and the magnetic system 2 respectively, into a position corresponding to the “off” position. The “off” position means the position of the armature 3 which in the preferred embodiment of a switching device and the tripping module 1 leads to an actuation of the latch 35, and therefore to the cut-off of the switching device. the armature 3 has a shoulder, as can be clearly seen in FIG. 7, in order to define an end position of the armature 3 relative to the coil 4 or yoke 5. The position of armature 3 which is opposite of the “off” position as is shown in FIG. 6 in which the armature 3 is held closest to the yoke cover 8, is designated at the so-called “on” position.

As shown in particular in FIGS. 1 to 3, the tripping module 1 has an insulant housing with an upper part 40 and a bottom part 41. The insulant housing accommodates further mechanical components in addition to the magnetic system 2 to transmit the movement of the armature 3 to the switching device, such as the circuit breaker 17. The upper part 40 and the bottom part 41 are connected with each other by means of two latching noses 42. All assemblies of the tripping module 1 are held in the bottom part 41. The upper part 40 includes the functional interfaces and respective openings to the switching device. The tripping module 1 further includes electric feed lines 50 and a printed circuit board 51 with electronic line-side components such as resistors and/or rectifiers, with the printed circuit board making contact with the electric connections 52 of the magnetic system 2. It can also be provided that the electric connections 52 of the magnetic system 2 are connected directly with the electric feed lines 50, without interposed line-side components.

The mechanical components involve a tripping slide 43 which transmits the straight movement of the armature 3 as a straight movement and optionally actuates the latch 35 of a breaker mechanism 37. Furthermore, a so-called reset 44 is arranged in the tripping module 1 which is arranged as a rotatably held lever whose first lever arm 45 is in engagement with the tripping slide 43 and whose second shorter lever arm 46 is loaded by a tension spring 47 fastened to the housing. The tripping slide 43 and thus also armature 3 is forced into the “on” position by the tension spring 47 via the reset 44 insofar as the reset 44 is not moved to another position, with the effect of the tension spring 47 on the armature 3 being preferably larger than the effect of the armature spring 39 which acts against the tension spring 47. In a switching device with built-in tripping module 1, the reset 44 is in engagement with the actuating lever 27 via a pin 48. In the case of a position of the actuating lever 27 which corresponds to the activated switching device in the sense of switching contacts 24 which are in contact with each other, the reset 44 is brought to a position by the actuating lever 27 and the pin 48 against the action of the tension spring 47 in which it is possible for armature 3 to assume the “off” position. The disconnecting apparatus 16 of the switching device can thus be triggered and the switching contacts 24 can be disconnected. At the same time, the actuating lever 27 is pivoted to a position corresponding to a deactivated switching device, through which the reset forces the armature 3 to the “on” position by the action of the tension spring 47, thus enabling a renewed latching of the breaker mechanism 37.

FIGS. 1 to 4 and FIGS. 6 and 7 show the tripping module 1 as well as the magnetic system 2 for the tripping module 1 which is configured as a shunt release. The tripping module 1 cuts off the switching device in response to a predeterminable electric signal, such that after receiving such a predeterminable electric signal the armature 3 moves from the “on” position to the “off” position. At least one permanent magnet 14 is arranged between the yoke cover 8 and the first spacer plate 13, with the permanent magnet 14 providing a predeterminable magnetic action of force. The permanent magnet 14 and the first spacer plate 13 are held on the coil body 11, which is preferably configured as a plastic part. A magnetomotive force thus occurs in the material of the magnetic circuit 2 which especially causes a magnetic force on the armature 3 in the direction of the first spacer plate 13.

In the case of a suitable predeterminable magnetization of the permanent magnet 14 and suitable choice of the properties of the armature spring 39, a bistable system is obtained: The armature 3 will either assume an end position closest to the first region 9 of yoke 5 (“off” position) or an end position on the spacer plate 13 in the area of the yoke cover 8 (“on” position). As a result of a current flow in the coil windings 12, a magnetic field and a magnetomotive force are generated in the described magnetic circuit 2, which is superimposed on the magnetic flux which is generated by the permanent magnet 14 and weakens the same. As a result, the spring force of the armature spring 39 exceeds the holding force of the permanent magnet field of the permanent magnet 14 and moves the armature 3 from the “on” position to the “off” position. The adjustment of the ampere windings of the coil winding 12 required for critical field build-up is provided via a predetermined line-side wiring of the coil 4 via series resistors which can also be arranged in the tripping module 1. In addition, a rectifier circuit for generating a pulsed direct current for supply to the coil can be used, thus exiting only the field polarization in the magnetic circuit 2 which is required for tripping.

The dimensioning of the coil wire or the windings of the coil winding 12 is configured for pulse loading in the case of an arrangement of the tripping module 1 as a shunt release. The voltage supply of the coil windings 12 therefore needs to be interrupted after the performed tripping of the switching device or disconnecting apparatus 16 in order to prevent any damage to the coil windings 12. A switch is especially provided in the case of the arrangement of the tripping module 1 as a shunt release, which switch is arranged within the assembly of the tripping module 1 and is preferably configured as a so-called microswitch 49. The microswitch 49 is arranged in such a way that it is in engagement with the actuating lever 27 in the case of arrangement of the tripping module 1 in the respective receptacle of the upper housing shell 22, at least when the actuating lever 27 is in the position of a deactivated switching device. By switching the voltage supply to coil 4 via the microswitch 49 it can be ensured that after the deactivation of the switching device the supply of further electric power to the coil winding 12 is interrupted, so that the thermal overload of the coil windings 12 can be prevented.

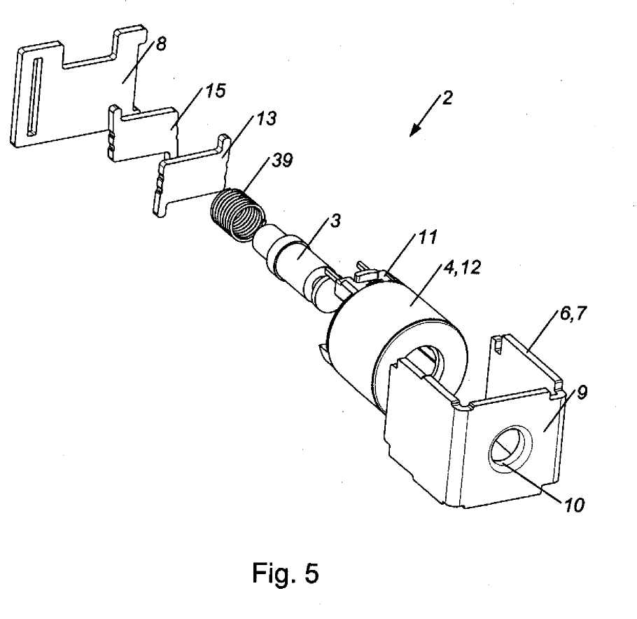

FIG. 5 shows a magnetic system 2 for the tripping module 1 which is configured as an undervoltage release. The tripping module 1 is connected by means of feed lines 50 with the electrical connections of the electric line network to be protected. When the voltage in the electric line network drops, the switching device or circuit breaker 17 coupled with the tripping module 1 is to be triggered or cut out by the tripping module 1. For this purpose, at least a second spacer plate 15 containing ferromagnetic material is arranged between the first spacer plate 13 and the coil winding 12. In the case of unchanged geometric conditions as in the arrangement of the tripping module 1 as a shunt release, a second spacer plate 15 is provided instead of the permanent magnet 14. As a result, no static magnetization is present in the magnetic circuit 2, through which the armature 3 remains in the “off” position in the first region 9 of yoke 5 by the relaxed armature spring 39. When the coil 4 is supplied with current and therefore supplied with electric power and when the ampere windings exceed a predeterminable value which is equivalent to a predeterminable voltage drop via the connections of the coil windings 12, the armature 3 can be held against the force of the armature spring 39 in the “on” position on the first spacer plate 13. If the voltage at the connections of the coil windings 12 falls beneath the voltage required for holding the armature in the “on” position, the force of armature spring 39 exceeds the magnetic force and the armature 3 is moved to the “off” position. The predeterminable voltage at the coil windings 12 which is necessary for holding the armature 3 in the “on” position is set via series resistors which can also be a part of the tripping module 1. The same applies to the polarization of the magnetic field generated by the coil windings 12. Since current continually flows through the coil windings 12 in the formation of the tripping module 1 as an undervoltage release, they must also be configured for this kind of load. An additional microswitch 49 can therefore preferably be omitted, as in the shunt release.

Further embodiments in accordance with the invention merely have a part of the described features, with any combination of features being provided, especially such of differently described embodiments.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A tripping module for a switching device, comprising at least a magnetic system including at least an armature constructed for tripping at least indirectly a disconnecting apparatus of a switching device, a coil arranged about the armature, and a yoke arranged about the coil and including at least a bent sheet-metal part.

2. The tripping module of claim 1, wherein the bent sheet-metal part is a bent punched part.

3. The tripping module of claim 1, wherein the yoke is made of a predetermined number of bent sheet-metal parts.

4. The tripping module of claim 1, wherein the yoke comprises a substantially U-shaped yoke base body and a substantially planar yoke cover for connection to the base body.

5. The tripping module of claim 4, wherein the yoke base body and the yoke cover are connected by a plug-in connection to close the yoke.

6. The tripping module of claim 4, wherein the yoke base body has a first region in opposite relationship to the yoke cover, said first region including a breakthrough for passage of the armature.

7. The tripping module of claim 1, wherein the coil comprises a coil body and a coil winding arranged on the coil body.

8. The tripping module of claim 7, wherein the yoke comprises a substantially U-shaped yoke base body and a substantially planar yoke cover for connection to the base body, and further comprising at least one first spacer plate arranged between the yoke cover and the coil winding.

9. The tripping module of claim 8, wherein the first spacer plate is held in or on the coil body.

10. The tripping module of claim 7, wherein the yoke comprises a substantially U-shaped yoke base body and a substantially planar yoke cover for connection to the base body, wherein at least one member selected from the group consisting of the yoke base body, the yoke cover, the armature, and the first spacer plate contains ferromagnetic material.

11. The tripping module of claim 8, constructed in the form of a shunt release, further comprising at least one permanent magnet arranged between the first spacer plate and the coil winding.

12. The tripping module of claim 8, constructed in the form of an undervoltage release, further comprising a second spacer plate which contains ferromagnetic material and is arranged between the yoke cover and the first spacer plate.

13. The tripping module of claim 1, constructed as part of the switching device.

14. The tripping module of claim 1, wherein the switching device is a circuit breaker.
